(19) United States
(12) Patent Application Publication
(10) Pub. No.: US 2013/0119592 A1
(43) Pub. Date: May 16, 2013

(54) HYDRAULICALLY DAMPING BEARING

(71) Applicants: Andreas Erl, Hennigsdorf (DE); Ruediger Hack, Berlin (DE); Michael Ebert, Berlin (DE)

(72) Inventors: Andreas Erl, Hennigsdorf (DE); Ruediger Hack, Berlin (DE); Michael Ebert, Berlin (DE)

(73) Assignee: CARL FREUDENBERG KG, Weinheim (DE)

(21) Appl. No.: 13/812,162

(22) PCT Filed: Jul. 12, 2011
(86) PCT No.: PCT/EP11/03471

§ 371 Date: Jan. 25, 2013

(30) Foreign Application Priority Data
Jul. 28, 2010 (EP) 10 007 828.6

(51) Int. Cl. F16F 13/00; F16F 1/373

(52) U.S. Cl. CPC F16F 13/002; F16F 1/373
USPC 267/220; 267/141; 267/121; 267/292

(57) ABSTRACT

A bearing, having: a support for fastening the bearing to a first body; a supporting bearing for fastening the bearing to a second body; and a multilayered spring which is integrated into the support and/or the supporting bearing and has an elastomer track which is arranged between two cover plates, wherein at least one of the cover plates has at least one projection which extends into the elastomer track from the one cover plate in the direction of the other cover plate.

### CROSS-REFERENCE TO RELATED APPLICATIONS

This application is a U.S. national phase application under 35 U.S.C. §371 of International Application No. PCT/EP2011/003471, filed on Jul. 12, 2011, and claims benefit to German Patent Application No. DE 10 007 828.6, filed on Jul. 28, 2010. The international application was published in German on Feb. 2, 2012, as WO 2012/013294 A1 under PCT Article 21(2).

### FIELD

The present invention relates to a bearing.

### BACKGROUND

Bearings are employed in order to provide isolation or damping against vibrations as well as to reduce noise pollution. Typical application cases are the bearings for passenger compartments, operator's cabs, motors and engines, transmissions, general machinery, aggregates and devices.

Aside from hydraulic bearings of the type described, for example, in German utility model DE 20 2005 021 498 U1, bearings that have a gas spring and that are referred to as air bearings are also generally known.

Aside from the optimization of the so-called rigid-body vibrations of a bearing system, it is becoming increasingly important to focus on the emission of noise. Time-related energy conductance plays a major role in this context.

The directed propagation of mechanical energy can be observed in solids, often in the form of individual pulses. Wave packets are also a frequent form in which these phenomena occur. Wave packets are mechanical vibrations that can be localized in time and space and that encompass a partial volume of a component. In this context, the particles that form the solid vibrate in a manner that is differently synchronized with respect to their momentary resting position. This effect can be measured macroscopically averaged over a volume or surface.

The curve of the maxima can be characterized by an envelope. If its largest value decreases in the direction of propagation as the wave packet progresses, the point of arrival with respect to the point of departure can be considered as being isolated with respect to this waveform (isolation effect)

An aspect of the invention provides an improved bearing with which the isolation effect for a directed transmission of mechanical vibrations and pulses between a seat and a support of the bearing is achieved.

### SUMMARY

An aspect of this invention provides a bearing, comprising: a support configured to fasten the bearing to a first body; a seat configured to fasten the bearing to a second body; and a layered spring that is integrated into the support, into the seat, or into the support and the seat, wherein the layered spring comprises an elastomer strip arranged between a first and a second cover plate, and wherein at least one of the cover plates comprises a projection that extends from one cover plate in the direction of the other cover plate and into the elastomer strip.

### BRIEF DESCRIPTION OF THE DRAWINGS

The invention will be explained in greater detail below on the basis of embodiments making reference to the accompanying figures of the drawing. The following is shown:

FIG. 1 a bearing arrangement according to an embodiment of the present invention, whereby half of a bearing thereof is depicted in a cutaway view;

FIG. 2 a bearing arrangement according to another embodiment of the present invention, whereby half of a bearing thereof is depicted in a cutaway view;

FIG. 3 a bearing arrangement according to yet another embodiment of the present invention, whereby half of a bearing thereof is depicted in a cutaway view; and

FIG. 4 an enlarged view A from FIG. 1 according to yet another embodiment of the present invention.

### DETAILED DESCRIPTION

Accordingly, a bearing is being put forward comprising the following: a support for fastening the bearing to a first body; a seat for fastening the bearing to a second body; and a layered spring that is integrated into the support and/or into the seat and that has an elastomer strip arranged between two cover plates; whereby at least one of the cover plates has at least one projection that extends from one cover plate in the direction of the other cover plate and into the elastomer strip.

A bearing arrangement comprising the bearing according to the invention, which supports a passenger compartment or an axle of a motor vehicle vis-à-vis the vehicle frame is also being put forward.

The idea upon which the present invention is based consist of the fact that the effectiveness of the isolation is attained in that elements of the bearing are non-positively connected in series in the direction of the energy transmission, and, on the basis of their design and of the selected material, they exhibit different frequency-dependent and amplitude-dependent behavior.

For instance, this is to be illustrated by way of an example in a rectangular pulse that is introduced into the seat in the direction of the support. Consequently, when the support is still resting, this results in a compression of the air-chamber volume (in those cases where the bearing is configured as an air bearing). For these considerations, it is assumed that the enclosed air volume executes a vibration with at least the lowest eigen frequency. Its mechanical energy is partially transferred to the other elements in the direction of propagation. This depends primarily on the mass properties and spring properties of these elements. On the basis of the damping properties of the materials in question, the excited vibration can be made to die out as a result of dissipation effects.

A material having a low density, a low degree of stiffness and a high level of damping will dissipate a large portion of the vibration energy, depending on the frequency and amplitude of the vibration excitation.

This is all the more successful when the boundary surfaces of such an area of the material display a large velocity differential in the direction of propagation of the mechanical energy. For this purpose, it is favorable to position an area of material functionally downstream in the direction of propagation, said material exhibiting a considerably higher degree of stiffness as well as higher density.

In the bearing according to the invention, such an arrangement is implemented in the axial direction by the layered spring.

Advantageous embodiments of the invention ensue from the subordinate claims.

The bearing can be employed, for example, in a generator, a cogeneration unit resting on a foundation, a cogeneration unit on an intermediate frame, a gear system of a wind turbine, an electrical cabinet, a physical device or instrument, a control station, especially a control station in ships, cranes or mobile or stationary heavy machinery, a pilot house in or on a ship or an operator's cab on a transport platform.

The elastomer strip can be made of rubber, polyurethane or a thermoplastic elastomer. It is also fundamentally possible to provide the cover plates of the layered spring without the at least one projection. The at least one projection, however, has the effect that it increases the stiffness of the layered spring and thus the overall stiffness of the bearing.

The term “flow-conducting” as set forth here refers to a liquid-conducting or gas-conducting connection, whereby a volume flow is created when the bearing is activated.

In another refinement of the bearing according to the invention, several projections are provided which are arranged alternately on the two cover plates in the plane of the elastomer strip. The term “in the plane” as set forth here means “as seen in the plane” or “along the plane”. This results in a meandering shape for the rubber strip, as seen in the cross section. This has the effect that the stiffness of the layered spring can be increased even further. This reduces the amplitudes that the bearing executes which, in turn, advantageously prolongs the service life of the bearing.

In another refinement of the bearing according to the invention, the one or more projections are arranged in a circle, at least in certain sections, around a center axis of the bearing. This prevents the establishment of a preferential direction. As result, the bearing exhibits uniform properties in all directions.

In another refinement of the bearing according to the invention, a gas spring is configured between the support and the seat, said gas spring being delimited by a bellows that is joined to the seat by means of a first thickened area of the bellows and/or to the support by means of a second thickened area of the bellows. The gas spring can contain air or another gas. The bellows is made of a flexible material, for instance, a flexible plastic. The first and second thickened areas entail the advantage that they make it easy to fasten or replace the bellows on the support and on the seat.

Instead of the gas spring, it is also conceivable to use a liquid in the bearing according to the invention and to arrange it between the support and the seat in such a way that it has a flow-conducting connection to a compensation vessel that displays expanding resilience. In this embodiment, the liquid replaces the volume occupied by the gas spring in the refinement described above. Consequently, the compensation vessel then functions as a spring. In this refinement as well, this results in a bearing with frequency-dependent behavior.

In another refinement of the bearing according to the invention, the first and/or second thickened area has a triangular cross section that is frictionally connected to the seat and/or to the support. Such a triangular cross section is particularly well-suited to generate a frictional connection.

In another refinement of the bearing according to the invention, the first and/or second thickened area engages into a corresponding groove in the seat or in the support and/or the first and/or second thickened area is pressed into the groove. As a result, the bellows is secured in the groove by a positive fit. Due to the fact that the first and/or second thickened area is pressed into the groove, the bellows can be reliably secured in the groove, even in the case of pronounced expansions.

In another refinement of the bearing according to the invention, the groove is formed in a bolt of the seat and the first thickened area is pressed into the groove by means of a pressure pad screwed to the bolt, whereby the pressure pad preferably has a screw that exerts pressure against the first thickened area by means of a washer that can rotate around the shank of the screw. When the screw is tightened, it can rotate with respect to the washer, so that only small torques are transmitted to the first thickened area.

In another refinement of the bearing according to the invention, the groove is formed between a rolling element of the support along which the bellows rolls and a section of the support that holds the rolling element, and/or the groove is formed between a rolling element of the seat along which the bellows rolls and a section of the seat that holds the rolling element, and/or the groove is formed in a rolling element of the support or of the seat. The rolling element is preferably made of a material that differs from that of the section of the support or of the seat that holds the rolling element. For example, the rolling element can be made of a polymer, especially polyamide. The section of the seat that holds the rolling element can especially be a bolt of the seat.

In another refinement of the bearing according to the invention, a bolt of the seat is surrounded in the radial direction by a rolling element along which a bellows that delimits a gas spring of the bearing rolls. In this manner, the bolt acquires a dual function: on the one hand, it serves to fasten the bearing, for example, to a frame of a vehicle and, on the other hand, it serves as a seat element for the rolling element.

In another refinement of the bearing according to the invention, the support and/or the seat comprises a connection for a supply line for gas exchange between a gas spring of the bearing and a compensation device, especially a compensation vessel. By means of the equalization device, the pressure of the gas spring can be regulated, as is described, for example, in German patent specification DE 34 34 659 C2. The connection of the support is preferably arranged so as to be off-centered relative to a center axis of the bolt or of the layered spring in order to prevent a collision with a limit stop that is optionally provided and that will be described in greater detail below.

In another refinement of the bearing according to the invention, the elastomer strip is functionally series-connected non-positively to a gas spring of the bearing. This means that the elastomer strip and gas spring are arranged one after the other in one direction and that they are non-positively coupled to each other.

In another refinement of the bearing according to the invention, a gas spring as well as a limit stop are provided, whereby the limit stop is arranged on the cover plate of the layered spring that delimits the gas spring and/or the limit stop is arranged on a pressure pad of a bolt of the bearing. Accordingly, the limit stop extends into the gas spring. The limit stop is preferably arranged coaxially to a center axis of the bolt and/or of the layered spring.

In another refinement of the bearing according to the invention, a volume of the bearing forming a gas spring consists of a solid cylinder, a hollow cylinder and/or a half torus.

The eigen frequency of the bearing arrangement according to the invention is preferably between 1 Hz and 3 Hz.

In another refinement of the bearing according to the invention, the gas spring is connected to an equalization device for purposes of allowing gas exchange.

The pressure of the gas spring can be set in this manner. Preferably, the gas spring has a flow-conductive connection to a separate, structurally detached compensation vessel, whereby the ratio of length to flow cross section of the line that allows the flow is not too small. An essential result is an obvious frequency-dependent behavior on the part of the bearing thus formed. When the dynamic stiffness is plotted over the excitation frequency and when an appropriate selection of the constant effective influencing variables is made, one obtains a curve that stands out for the features presented below. In the case of small excitation frequencies, the dynamic stiffness virtually matches the static value, and subsequently, the value first drops below (minimum), then markedly exceeds, and subsequently drops to a steady-state value that is lower than this maximum over a larger frequency range. Here, this steady-state value is greater than the stiffness value at small excitation frequencies below the frequency of the minimum. The advantage of the bearing lies in the largely independent adjustability of the properties pertaining to load-bearing capacity and spring stiffness. Thus, in the case of an otherwise identical deflection, a larger load can be absorbed by the bearing merely by raising the gas spring pressure. In the case of a large ratio between the volume of the gas spring and the effective piston surface area, this causes practically no change in the static stiffness around the working point. If the installation conditions at hand allow this and if the vibration situation requires it, the bearing according to the invention can be employed with a compensation vessel connected via a connection line, in order to achieve better isolation of the bearing-mounted mass vis-à-vis a periodical excitation at low frequencies. This can be achieved by means of a coordination step in which the minimum of the dynamic stiffness is coordinated with the interference frequency that is to be isolated.

Unless otherwise indicated, identical or functionally identical components are designated by the same reference numerals in the Figures.

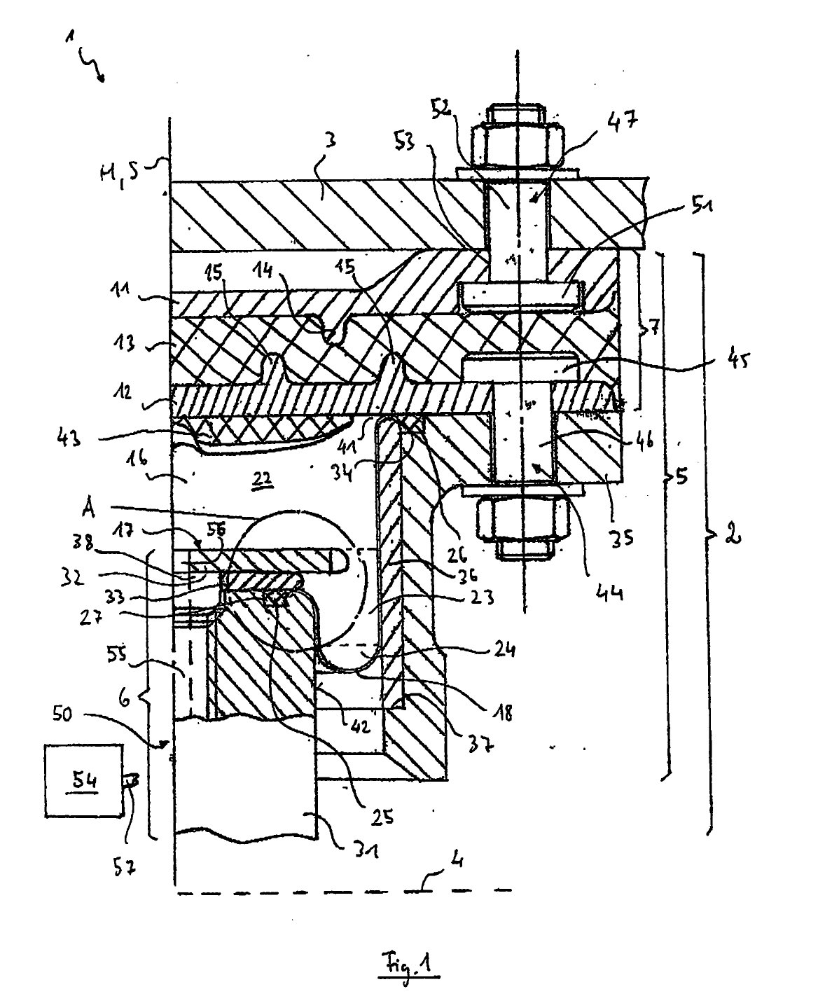

FIG. 1 shows bearing arrangement 1 according to an embodiment of the present invention, wherein half of a bearing 2 thereof is depicted in a cutaway view. An axis of symmetry of the bearing 2 is designated with the reference letter S in FIG. 1.

The bearing 2 supports the floor 3 of a passenger compartment (not shown here) against a frame 4 (indicated by a broken line) of a vehicle (not shown here).

The bearing 2 has a support 5 that is fastened to a passenger compartment floor 3. Moreover, the bearing 2 has a seat 6 that is fastened to the frame 4. Furthermore, the bearing 2 comprises a layered spring 7 that is integrated into the support 5.

The layered spring 7 has two cover plates 11, 12 arranged one above the other and between which there is an elastomer strip 13. A projection 14 that extends in the direction of the lower cover plate 12 is formed on the upper cover plate 11. Two projections 15 that extend in the direction of the upper cover plate 11 are formed on the lower cover plate 12. The projections 14, are provided alternately in the plane of the elastomer strip 13, resulting in the following sequence: projection 15, projection 14, projection 15. This imparts the elastomer strip 13 with a meandering shape. The projections 14, 15 brake a radial movement within the elastomer strip 13, as a result of which the overall stiffness of the layered spring 7 is increased. Here, the term “radial” refers to a center axis M of the bearing 2 that coincides with the axis of symmetry S here. The projections 14, 15 can also be configured, for instance, as beads in the cover plates 11, 12. Moreover, the projections 15 can extend in a circle around the center axis M.

A gas spring 16 is provided between the support 5 and the seat 6. The gas spring 16 is a volume of a gas or gas mixture, for instance, air. The gas spring is delimited towards the top by a cover plate 12 and towards the bottom by a pressure pad 17 of the seat 16, which will be explained in greater detail later on. The gas spring 16 is laterally delimited by a bellows 18. Therefore, the volume of the gas spring 16 consists of a solid cylinder 22, a hollow cylinder 23 and a half torus 24.

The bellows 18 has thickened areas 25 and 26 on its opposite ends. The thickened areas 25 and 26 each have an essentially rectangular cross section.

The thickened area 25 is arranged in a groove 27 in a bolt 31 of the seat 6. The bolt 31 is joined to the frame 4 in order to join the seat 6 to the frame 4, as described above. The pressure pad 17 has a screw 32 and a washer 33. The washer 33 can be rotated around a shank 38 of the screw 32. The screw 32 is screwed into the bolt 31 and, via washer 33, presses the thickened area 25 into the groove 27. As a result, the thickened area 25 is held in the groove 27 with a positive and frictional fit.

The thickened area 26 is arranged in a groove 34. The groove 34 is delimited by a sleeve-like section 35 of the support 5. Moreover, the groove 34 is delimited by a rolling element 36. The rolling element 36 is likewise, for example, sleeve-shaped and is held with a positive fit between a shoulder 37 in the section 35 and in the lower cover layer 12. The lower cover layer 12 presses the thickened area 26 into the groove 34, whereby the bellows 18 passes between the lower cover plate 12 and the rolling element 36 at the place designated with the reference numeral 41. The bellows 18 rolls along the rolling element 36 when the bearing 2 is actuated, that is to say, the support 5 moves relative to the seat 6. Opposite from the rolling element 36, the bellows 18 rolls along the outer surface 42 of the bolt 31.

A limit stop 43 is provided on the underside of the lower cover plate 12. The pressure pad 17 strikes against said limit stop 43 when the movements of the support 5 relative to the seat 6 are of a very large amplitude.

Preferably, the limit stop 43 is made of an open-cell foamed material so that the gas from the gas spring 16 can penetrate into it.

The section 35 can be fastened, especially flanged, onto the layered spring 7 by means of a bolt 44. Here, the head 45 of the bolt 44 can be sunk into the elastomer strip 13, and the shank 46 of the bolt 44 can extend through the lower cover layer 12, that is to say, the head 45 grips behind the lower cover layer 12. As an alternative, a non-positive connection could be provided between the cover layer 12 and the section 35.

Moreover, the bearing 2 is joined to the passenger compartment floor 3 by means of a bolt 47. The head 51 of the bolt 47 can be sunk into the upper cover layer 11 and its shank 52 can extend through a hole 53 into the upper cover layer 11, that is to say, the head 51 grips behind the upper cover layer 11.

In this manner, it is clear that the elastomer strip 13 is connected to the gas spring 16 with a non-positive fit, one after the other, along the center axis M, in other words, an energy flow runs from the passenger compartment floor 3 to the frame 4 and vice versa, always through the elastomer strip 13 and through the gas spring 16.

The bearing arrangement 1 also has an equalization device 54 for gas exchange with the gas of the gas spring 16. The gas equalization device 54 is merely indicated schematically in FIG. 1.

The gas equalization device 54 is connected to a connection 50 of the bearing 2 in a manner not shown here. The connection 50 comprises a channel 55 in the bolt 31, and this channel has a flow-conducting connection to the gas of the gas spring 16 through an opening 56 in the screw 32. A supply line that connects the equalization device 54 to the connection 50 or to the channel 55 is designated by the reference numeral 57 in FIG. 1.

The gas volume contained in the channel 55 is also employed here to achieve the desired vibration-related properties of the bearing 2. After all, the gas volume contained in the channel 55 also vibrates as a function of the cross section and the length of the channel 55 as well as of the excitation frequency and other factors when the bearing 2 is actuated, thus also influencing on the vibration-related properties of the bearing 2.

The equalization device 54 can be configured, for instance, as a gas tank. Furthermore, the equalization device 54 can be configured to charge additional gas into the gas spring 16 or to release gas from the gas spring 16 in order to adjust the distance between the support 5 and the seat 6.

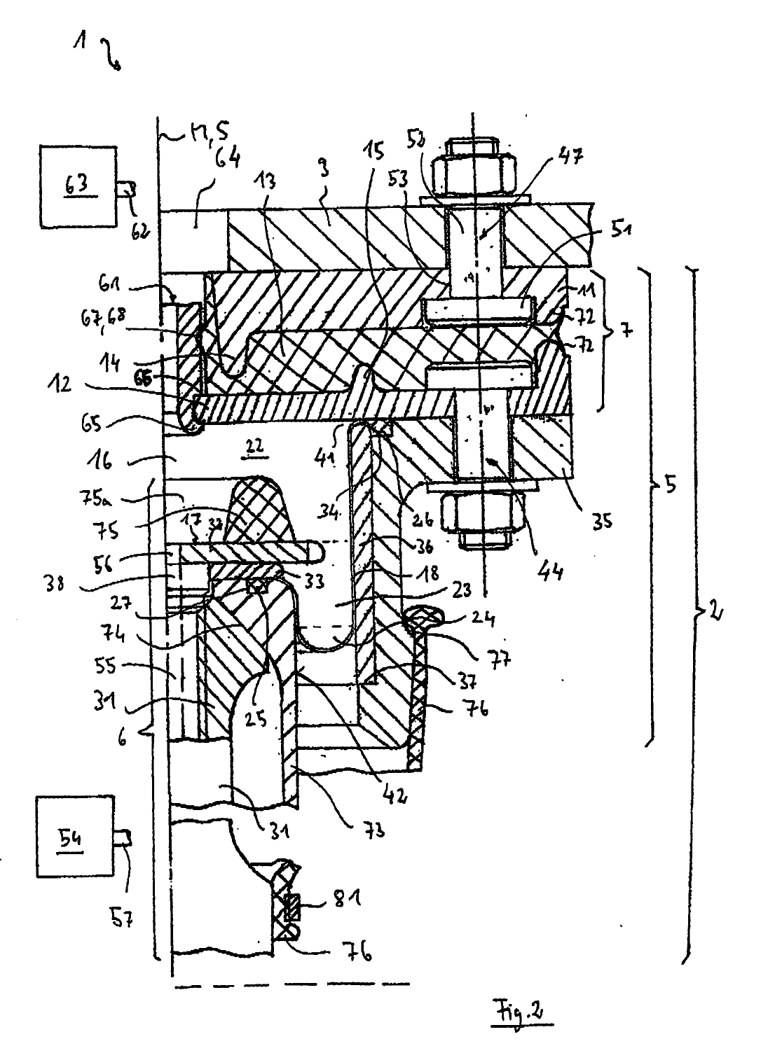

FIG. 2 shows a bearing arrangement 1 according to another embodiment of the present invention, whereby half of the bearing 2 thereof is depicted in a cutaway view.

Below, only differences between the bearing arrangement 1 according to FIG. 2 and the bearing arrangement 1 according to FIG. 1 will be elaborated upon.

The bearing 2 according to FIG. 2 is provided with a connection 61 on the support side in order to connect an additional supply line 62 to an additional equalization device 63. The equalization device 63 preferably serves to adjust the distance between the support 5 and the seat 6.

The connection 61 extends in a manner not shown in greater detail here through an opening 64 in the passenger compartment floor 3 and through the layered spring 7 all the way into the gas spring 16. The connection 61 is configured in the form of a sleeve that is positively connected to the lower cover layer 12 by means of a flange 65 and a shoulder 66. Moreover, the connection 61 has a surface-pressure means 67 with a section 68 of the elastomer strip 13 that is pulled upwards. The surface-pressure means 67 ensures a gas-tight and liquid-tight seal between the elastomer strip 13 and the connection 61.

As can be seen in FIG. 2, only two projections 14, 15 are provided and they extend into the elastomer layer 13.

Furthermore, projections 72 are provided on the edge of the upper and lower cover layers 11, 12, and these projections 72 are essentially opposite from each other, extend towards each other and preferably run in a circle around the center line M.

In contrast to the embodiment according to FIG. 1, in the embodiment according to FIG. 2, the groove 25 is arranged in a rolling element 73 on the seat side, said rolling element 73 surrounding the circumference of the bolt 31. The rolling element 73 as well as the bolt 31 taper conically, which is indicated by the reference numeral 74, all the way to the gas spring 16. For this reason, the bellows 18 rolls along the rolling element 73 in the embodiment according to FIG. 2.

Instead of the limit stop 43 as shown in FIG. 1, the bearing 2 of FIG. 2 has a limit stop 75 that is essentially ring-shaped and has an approximately parabolic cross section. The limit stop 75 is arranged coaxially on the center axis M of the bearing 2. Owing to the centered opening 75a of the limit stop 75, the opening 56 of the channel 55 has a flow-conducting connection to the gas spring 16. The limit stop 75, like the limit stop 43, can be made of a foamed material.

The bearing 2 also has a bellows 76 which is held, on the one hand, on the section 35 by means of an undercut 77 and, on the other hand, on the bolt 31 by means of a clamping ring 81. The bellows 76 protects the bellows 18 from dust and dirt, thus prolonging the service life of the bellows 18. The bellows 76 is made of a highly wear-resistant material.

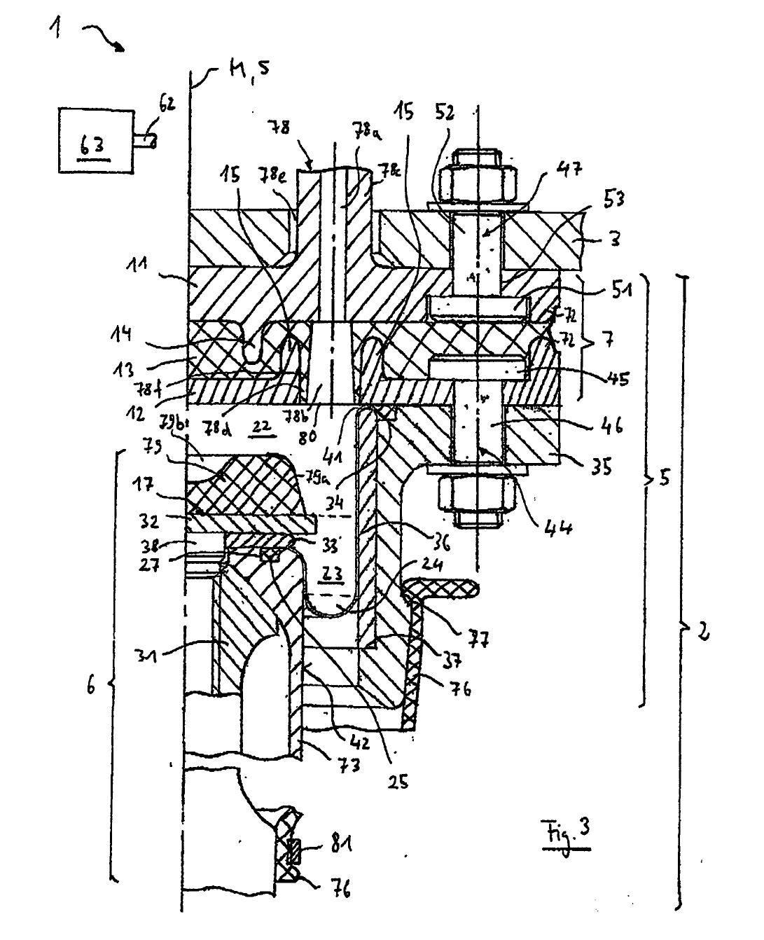

FIG. 3 shows a bearing arrangement 1 according to yet another embodiment of the present invention, whereby half of a bearing 2 thereof is depicted in a cutaway view.

Below, only the differences between the bearing arrangement 1 according to FIG. 3 and the bearing arrangement 1 according to FIG. 2 will be elaborated upon.

The bearing 2 according to FIG. 3, in contrast to the connection 61 on the support side shown in FIG. 2, involves a connection 78 on the support side for purposes of connecting the additional supply line 62 of the additional equalization device 63. The connection 78 is offset with respect to the center line M, in other words, it is arranged off-centered. The connection 78 is arranged offset in such a manner that a limit stop 79 on the support side, as seen along the center line M, in other words, along the direction in which the bearing 2 deflects, does not cover an opening 80 of the connection 78 on the gas spring side. As a result, the opening 80 remains free, even when the support 5 has been lowered onto the limit stop 79. The gas spring 16 has a flow-conducting connection to the equalization device 63 via the opening 80. The connection 78 can consist of a channel 78a that runs in the upper cover plate 11, and of a channel 78b that runs in the elastomer strip 13. The channel 78a can especially run in a protuberance 78c of the cover plate 11 extending upwards through an opening 78e in the passenger compartment floor 3. Moreover, the channel 78b can run in a protuberance 78d of the elastomer strip 13 extending downwards through an opening 78f in the lower plate 12. The projections 15 of the lower plate 12 can be provided in such a manner that they delimit this opening 78f.

The limit stop 79 on the seat side has a washer shape 79a with a depression 79b in the center. The limit stop 79 is arranged on the pressure pad 17.

In contrast to the embodiment according to FIG. 2, no channel 55 and thus no connection capability for the equalization device 54 are provided in FIG. 3. However, it would, of course, be possible to provide such a connection capability if necessary.

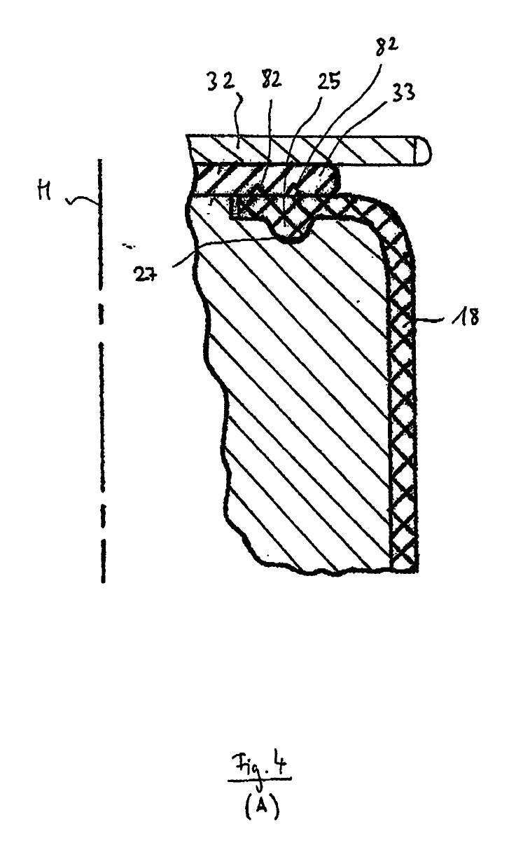

FIG. 4 shows an enlarged view A from FIG. 1 according to yet another embodiment of the present invention.

According to the embodiment of FIG. 4, the groove 27 is configured so as to be semi-circular. The underside of the thickened area 25 of the bellows 18 is correspondingly configured so as to be semi-circular. The top of the thickened area 25 of the bellows 18 has triangular cross sections 82 that lie against the washer 33 with a frictional connection. The triangular cross sections 82 are preferably configured so as to surround the center line M. The circular cross sections 82 further improve the frictional connection between the bellows 18 and the washer 33.

The bearing 2 is particularly well-suited in cases of repair or replacement. The following sequence can be given below in order to illustrate this.

In order to replace the bearing 2, see FIG. 1, the passenger compartment is first supported against the effect of gravity, so that no shift in height occurs. Now, the bearing 2 can be uncoupled from the compensation vessel 54, 63 that relieves the excess pressure in the bearing 2 vis-à-vis the bearing environment; any connection lines 57, 62 leading to the compensation vessel 54, 63 that might be present are then disconnected and removed.

Subsequently, the screwed connection 47 between the support 5 and the passenger compartment floor 3 is disconnected and the support 5 is lowered until it is resting on the seat 6 via the limit stop 43.

The screwed connection 47 of the seat 6 to the frame 4 can then be released.

This work sequence can also be correspondingly applied to other bearing situations. In this manner, a bearing 2 is formed that is well-suited for maintenance purposes.

Although the invention was described here on the basis of preferred embodiments, it is not restricted to these, but rather, it can be modified in many different ways. In particular, the term “one” does not preclude the plural.

In particular, it should be pointed out the embodiments according to FIGS. 1 to 3 described here can be combined with each other at will. For instance, the embodiment according to FIG. 1 could also have the rolling element 73 according to FIG. 2. Or else, the fastening technique of the thickened area 26 of the bellows 18 could be correspondingly provided for the thickened area 25.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

1. A bearing, comprising:
a support configured to fasten the bearing to a first body;
a seat configured to fasten the bearing to a second body; and
a layered spring that is integrated into the support, into the seat, or into the support and the seat,
wherein the layered spring comprises an elastomer strip arranged between a first and a second cover plate, and
wherein at least one of the cover plates comprises a projection that extends from one cover plate in the direction of the other cover plate and into the elastomer strip.

2. The bearing of claim 1, comprising two or more projections, which are arranged alternately on the two cover plates in a plane of the elastomer strip.

3. The bearing of claim 1, wherein one or more projections are arranged in a circle, at least in certain sections, around a center axis of the bearing.

4. The bearing of claim 1, further comprising:
a gas spring between the support and the seat,
wherein the gas spring is delimited by a bellows,
wherein the bellows is joined (i) to the seat by a first thickened area of the bellows, (ii) to the support by second thickened area of the bellows, or (iii) to the seat by the first thickened area and to the support by the second thickened area.

5. The bearing of claim 4, wherein the first thickened area, the second thickened area, or the first and the second thickened area has a triangular cross section that is frictionally connected to the seat, the support, or the seat and the support.

6. The bearing of claim 4, wherein the first thickened area, the second thickened area, or the first and the second thickened area engages into a corresponding groove in the seat, the support, or the seat and

[symbol]

7. The bearing of claim 6, wherein the groove is formed in a bolt of the seat, and
wherein the first thickened area is pressed into the groove by a pressure pad screwed to the bolt.

8. The bearing of claim 6, wherein the groove is formed in at least one of
(i) between a rolling element of the support along which the bellows rolls and a section of the support that holds the rolling element,
(ii) between a rolling element of the seat along which the bellows rolls and a section of the seat that holds the rolling element, and
(iii) in a rolling element of the support or of the seat.

9. The bearing of claim 1, wherein a bolt of the seat is surrounded in a radial direction by a rolling element along which a bellows that delimits a gas spring of the bearing rolls.

10. The bearing of claim 1, characterized in that the support, the seat, or the support and the seat comprises a connection for a supply line for gas exchange between a gas spring of the bearing and a compensation device.

11. The bearing of claim 1, wherein the elastomer strip is functionally series-connected non-positively to a gas spring of the bearing.

12. The bearing of claim 1, further comprising:
a gas spring; and
a limit stop,
wherein the limit stop is arranged on a cover plate of the layered spring that delimits the gas spring, or
wherein the limit stop is arranged on a pressure pad of a bolt of the bearing, or
wherein a limit stop is arranged on the cover plate of the layered spring that delimits the gas spring and a limit stop is arranged on the pressure pad of the bold of the bearing.

13. The bearing of claim 1, wherein a gas volume of the bearing forming a gas spring comprises a solid cylinder, a hollow cylinder, a half torus, of a combination thereof.

14. A bearing arrangement, comprising:
the bearing of claim 1, wherein the bearing is configured to support a passenger compartment or an axle of a motor vehicle with respect to the vehicle frame.

15. The bearing arrangement of claim 14, wherein the bearing comprises a gas spring, and the gas spring is connected to an equalization device configured to allow gas exchange.

16. The bearing of claim 7, wherein the pressure pad comprises a screw that exerts pressure against the first thickened area with a washer that can rotate around a shank of the screw.

17. The bearing of claim 4, wherein the first thickened area, the second thickened area, or the first and the second thickened area is pressed into the groove.

18. The hearing of claim 6, wherein the first thickened area, the second thickened area, or the first and the second thickened area is pressed into the groove.

19. The bearing of claim 12, wherein the limit stop is arranged on a cover plate of the layered spring that delimits the gas spring.

20. The bearing of claim 10, wherein the compensation device is a compensation vessel.
